(19) United States
(12) Patent Application Publication
(10) Pub. No.: US 2008/0151772 A1
(43) Pub. Date: Jun. 26, 2008

(54) DISPLAY METHODS AND APPARATUS FOR TRANSMISSION CHARACTERISTICS

(75) Inventors: Yoneo Akita, Tokyo (JP); Koichi Sega, Saitama (JP)

Correspondence Address: MATTHEW D. RABDAU;TEKTRONIX, INC., 14150 S.W. KARL BRAUN DRIVE, P.O. BOX 500 (50-LAW), BEAVERTON, OR, 97077-0001, US

(73) Assignee: TEKTRONIX INTERNATIONAL SALES GMBH, Rheinfall (CH)

(21) Appl. No.: 11/835,364

(22) Filed: Aug. 7, 2007

(30) Foreign Application Priority Data
Aug. 8, 2006 (JP) 2006-216142

(51) Int. Cl. G06F 11/30

(52) U.S. Cl. 370/252

(57) ABSTRACT

A signal processing block 16 calculates propagation characteristics of a propagation path from a signal under test. A display block 17 displays the propagation characteristics calculated by the signal processing block 16. The propagation characteristics are displayed on a two dimensional coordinate of which one axis is elapsed time, and the calculated results of the propagation characteristics are represented with colors or brightness on the two dimensional coordinate. For example, powers or phases are represented with colors or brightness on a two dimensional coordinate of which axes are frequency and elapsed time to display the transfer functions. Amplitudes of delay profiles are represented with colors or brightness on a two dimensional coordinate of which axes are delay time and elapsed time to display the delay profiles.

### BACKGROUND

Embodiments of the present invention relate to methods and apparatus for displaying propagation characteristics such as delay in a propagation path, time variation of delay profile to easily and certainly determine the propagation characteristics.

With the rise of recent digital communication technology, various digital communication apparatuses realizing mobile communication, such as wireless LAN (Local Area Network) cards, mobile phones, one segment receiving terminals for terrestrial digital broadcasting, etc., have been used.

The wireless LAN cards, for example, conduct the first demodulation to transmit information using different symbol rates such as QPSK, 16QAM, etc. depending on transmission condition, and the second demodulation with OFDM (Orthogonal Frequency Division Multiplexing) and converts it to a wireless signal to transmit the information.

The communication with digital demodulation provides a wireless communication having durability against distortion and/or interference. If the first demodulation adopts, for example, QPSK, it has defined four positions that the symbols should be located on an IQ plane. Therefore, even if the symbols depart from the ideal positions to some extent due to phase or amplitude distortion in the propagation process it is possible to determine which symbols the original signal has, which can prevent loss of the information. The OFDM uses a plurality of carriers for the communication. Then even if the total communication speed is fast, a transmission rate of each carrier can be low, which suppresses bad influence due to multipath.

As a method for measuring characteristics of a transmission circuit using the transmission systems as described above, the patent document 1 disclosed a method that estimates ideal symbols using symbols obtained by demodulating a digital modulated signal and calculates amplitude linearity between an ideal digital signal derived from modulating the ideal symbols and the digital modulated signal.

A spectrum analyzer is used for measuring quality of wireless communications. As disclosed in the patent document 2, the spectrum analyzer has a function of displaying spectrogram that shows magnitudes of the respective frequencies along elapsed time. The spectrogram display indicates frequencies with one axis of a two dimensional coordinate, time with the other axis and magnitudes of spectrums with colors or brightness.

It is known that radio wave propagation characteristics from a transmitter to a receiver changes dramatically depending on movement of the transmitter and/or receiver during the mobile communication. Therefore, it is important to analyze the time variation of the propagation characteristics for better communication quality.

Transfer function and/or delay profile are generally measured for the analysis of the propagation characteristics but this measurement evaluates characteristics at a moment. Then, to determine the time variation it is necessary to evaluate a series of temporal characteristics, which makes it difficult to see the time variation of the characteristics. If the measurement result is displayed as a three dimensional waterfall as shown in FIG. 1 (Prior Art), a small peak located in the back may be hidden by a large peak in the front, which may cause not to see the measurement results.

### SUMMARY

Accordingly, embodiments of the present invention provide methods and apparatus for displaying the propagation characteristics of a wireless signal to easily and certainly see the time variation of the propagation characteristics.

Embodiments of a method for displaying propagation characteristics according to the present invention comprise a step of calculating propagation characteristics of propagation path from a signal under test, and a step of displaying the calculated propagation characteristics wherein the propagation characteristics are displayed on a two dimensional coordinate, one axis of the two dimensional coordinate is time (elapsed time) and the calculated results of the propagation characteristics are represented with colors or brightness on the two dimensional coordinate in the displaying step.

An embodiment of apparatus for measuring propagation characteristics according to the present invention comprise a signal processing block for calculating propagation characteristics of a propagation path from a signal under test and a display block for displaying the calculated propagation characteristics wherein the display block displays the propagation characteristics on a two dimensional coordinate, one axis of the two dimensional coordinate is time (elapsed time) and the calculated results of the propagation characteristics are represented with colors or brightness on the two dimensional coordinate.

According to embodiments of the present invention, transfer functions are calculated as the propagation characteristics and amplitudes or phases of the transfer functions are represented with colors or brightness on a two dimensional coordinate of which axes are frequency and time (elapsed time) to display the transfer functions. Besides, delay profiles are calculated by conducting Fourier transform of the calculated transfer functions and amplitudes of the delay profiles are represented with colors or brightness on a two dimensional coordinate of which axes are delay time and time (elapsed time) to display the delay profiles.

According to embodiments of the present invention, propagation characteristics are displayed on a two dimensional coordinate wherein one axis of the two dimensional coordinate is time and the calculated results of the propagation characteristics are represented with colors or brightness on the second dimensional coordinate.

Therefore, time variation of the propagation characteristics are easily and certainly realized without causing some troubles such as not to be able to see measurement results because a waveform is hidden like in a three dimensional waterfall display. Besides, embodiments of the present invention make it more effective when designing mobile transmitter/receiver, to make settings of a transmitter station, etc. because it makes it possible to easily realize time variation of the propagation characteristics in an analysis of propagation characteristics of a radio wave, such as that produced by mobile communication.

The invention will now be described in additional detail, by way of example, with reference to the accompanying drawings.

### BRIEF DESCRIPTION OF THE FIGURES

FIG. 1 (Prior Art) is a figure illustrating a waterfall display

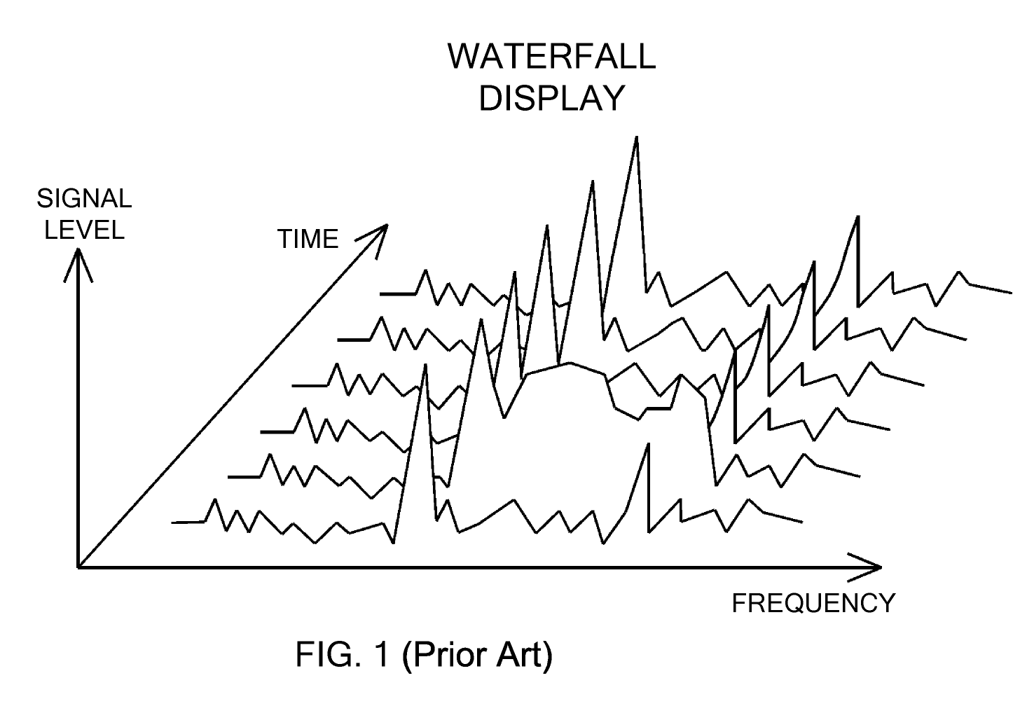

FIG. 2 is a block diagram of a propagation characteristic measurement apparatus

FIG. 3 is a flowchart showing operation of signal processing

FIG. 4 is a figure of showing signal points on a signal space diagram

FIG. 5 is a figure showing measurement results of transfer functions

FIG. 6 is a figure showing measurement results of delay profiles

### DETAILED DESCRIPTION

Embodiments of the present invention measure propagation characteristics of a propagation path using a digital modulated signal such as a broadcasting signal of the terrestrial digital broadcasting, of which transmitted content is unknown, as well as a digital modulated signal of which transmitted content is completely known, and makes it possible to easily and certainly see time variation of the propagation characteristics. However, note that it is known which digital modulation format the signal under test for measuring the propagation characteristics uses. Hereinafter, a case using OFDM as the second modulation is described, for example.

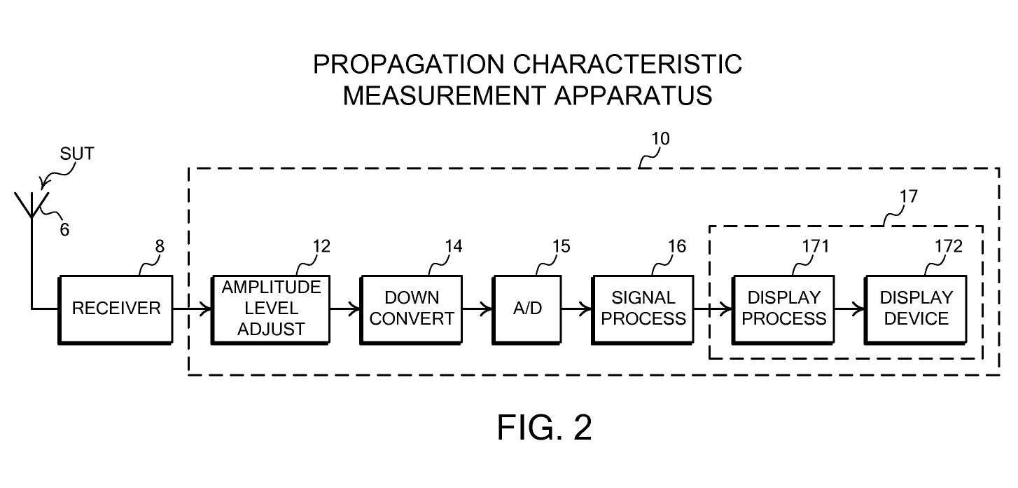

FIG. 2 is a block diagram of a digital modulated signal measurement system using a propagation characteristic measurement apparatus 10 according to embodiments the present invention. The propagation characteristic measurement apparatus 10 according to the present invention has hardware (not shown) as is well known for PC, and CPU controls each block according to program stored in a hard disk drive, etc. A memory such as a RAM may be used to store temporal data under processing. A user may make desired settings of the measurement apparatus 10 through mouse and/or operation panel (not shown).

The signal under test (SUT) may be a digital modulated signal; or a received signal, such as wireless LAN standardized as IEEE802.11a; terrestrial digital broadcasting, etc. A receiving circuit 8 converts the SUT through an antenna 6 to an electronic signal that is provided to an amplitude level adjusting block 12 through an input of the measurement apparatus 10.

The amplitude level adjusting block 12 has a preamplifier and/or attenuator to adjust amplitude of the input signal properly to provide it to an analog down converter 14. The down converter 14 has a mixer, a local oscillator and a band pass filter, and down converts frequencies of the input signal to intermediate frequencies (IF). An A/D conversion block 15 converts the IF signal to digital time domain data (hereinafter, called time domain data)

A signal processing block 16 further digitally down converts the time domain data according to user-set center frequency and span, conducts orthogonal demodulation and extracts a synch signal to extract base band complex signals that the user desires to measure as complex (IQ) data every symbol. In addition, it calculates propagation characteristics of the SUT and provides the calculated results to a display block 17 through processes described below.

The display block 17 has display processing block 171 and display device 172 and displays the propagation characteristics calculated by the signal processing block 16. The display processing block 171 of the display block 17 generates display drive signals based on the calculated results provided from the signal processing block 16 to provide it to the display device 172. The display device 172 displays the propagation characteristics along elapsed time on the screen according to the provided display drive signals.

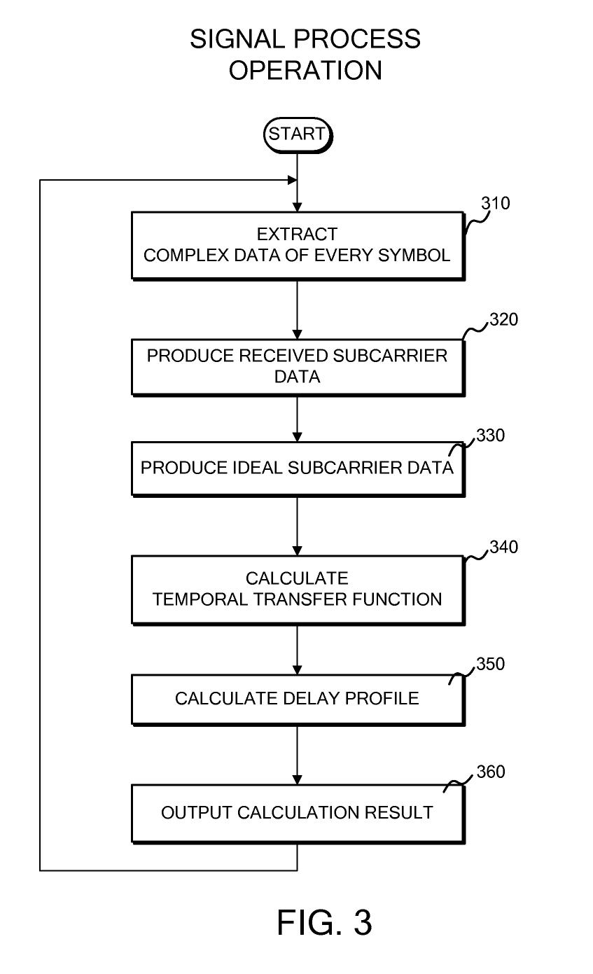

The signal processes done by the signal processing block 16 are described using a flowchart of FIG. 3.

In a step 310, the signal processing block 16 extracts complex data every symbol from the time domain data that is down converted and the process advances to a step 320. As described above the time domain data may have been down converted as and analog signal,. In a further embodiment, the time domain data may have been further down converted after being converted to a digital signal.

In the step 320, the signal processing block 16 conducts Fourier transform using the extracted complex data to produce received subcarrier data, and the process advances to a step 330.

In the step 330, the signal processing block 16 produces ideal subcarrier data (estimated transmitted subcarrier data).

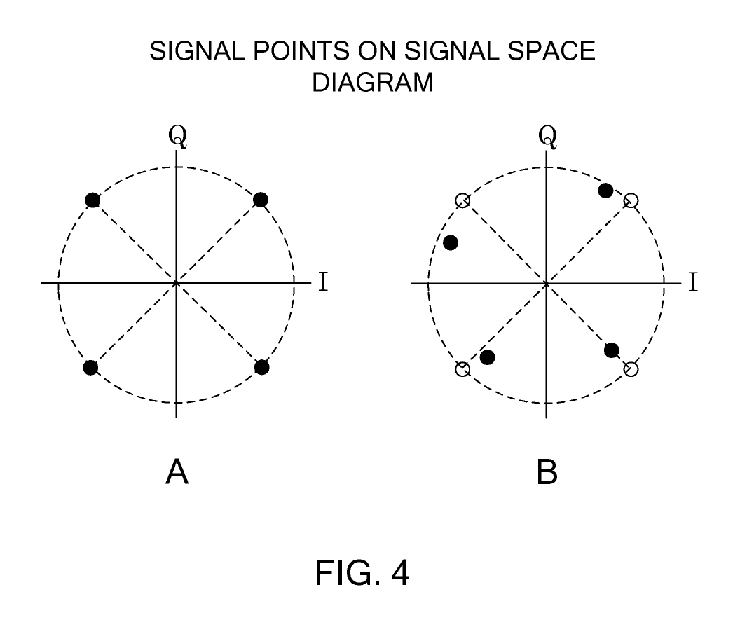

If the received subcarrier data is derived from a signal using, for example, QPSK modulation, the received subcarrier data without distortion and/or noise on a signal space diagram may be shown as FIG. 4A wherein lengths of segments between the origin and signal points (shown by black circles) based on the received subcarrier data, and angles between the segments and I and Q axes could be equal. But, in an actual case, there are shifts of amplitudes and/or phases of the signal points as shown in FIG. 4B because of influence of the propagation path wherein white circles show signal points without distortion and/or noise. It is known that the signal points move around the origin according to movement of a communication apparatus in the mobile communication system. Received subcarrier data is defined as multiplying transmitted subcarrier data and a transfer function wherein the received subcarrier data is a frequency component of received symbols and transmitted subcarrier data is a frequency component of transmitted symbols. Then ideal subcarrier data, or the transmitted subcarrier data, is created to calculate the transfer function that indicates influence of the propagation path.

The digital modulated signal usually includes known information such as for identifying modulation format and/or pilot subcarriers to revise the phase errors. Then, the ideal subcarrier data is estimated using the received carrier data and the above known information. Wherein ideal positions on an IQ plane the subcarrier data should be located at are defined depending on the modulation format. Therefore if a digital modulated signal under test does not have very large distortion, the ideal positions that are closest to the respective received carrier data can be deemed to be the ideal subcarrier data positions. Even if the digital modulated signal under test has distortion, the ideal subcarrier data can be estimated as disclosed in Japanese patent 3,598,371 by statistical process of demodulated signal points on the signal space diagram or signal points on the signal space diagram according to relative phase differences of demodulated signals.

In a step 340, the signal processing block 16 calculates temporal transfer functions. As described above, the received subcarrier data is defined as multiplying the transmitted subcarrier data and a transfer function. Therefore, the signal processing block 16 calculates the temporal transfer functions by dividing the received subcarrier data by the ideal subcarrier data produced at the step 330 for every subcarrier.

In a step 350, the signal processing block 16 conducts Fourier transform (e.g. discrete Fourier transform (DFT)) of the temporal transfer functions to calculate temporal delay profiles. This utilizes a transfer function that is flat if there is no delayed wave, but if there is a delayed wave it has a waveform indicating it. The waveform depends on delay time, amplitude ratio and phase difference relative to the main wave of the delay wave so that the temporal transfer functions could be deemed to have time property.

In a step 360, the signal processing block 16 provides the calculated temporal transfer functions and temporal delay profiles to the display processing block 171, and the process returns to the step 310 to calculate the temporal transfer functions and temporal delay profiles of the complex data of the next symbols.

As described, the temporal transfer functions and temporal delay profiles are repetitively calculated and the results are provided to the display processing block 171.

In the above embodiment, the signal processing block 16 produces the ideal subcarrier data using the received subcarrier data and the pilot subcarrier and calculates the transfer functions using the ideal subcarrier data. However, the calculation of the transfer function can be simplified by using only the known subcarrier data if the measurement does not require high precision. That is, an OFDM signal has pilot subcarriers in the subcarriers and the pilot subcarriers are derived from predetermined pilot symbols so that its transmitted subcarrier data is known. Therefore, received subcarrier data from the pilot subcarriers is divided by the respective transmitted subcarrier data. Since the pilot subcarriers are provided every so many subcarriers, quotients concerning subcarriers other than the pilot subcarriers are evaluated with interpolation, etc. using the above quotients concerning the pilot subcarriers to calculate the transfer functions.

The display block 17 conducts processes for displaying the propagation characteristics and displays the propagation characteristics along elapsed time based on the calculation results provided from the signal processing block 16. Wherein if the display block 17 displays the transfer functions as the propagation characteristics, it displays a two dimensional display having coordinate axes of frequency and elapsed time, and amplitudes or phases are represented with colors or brightness.

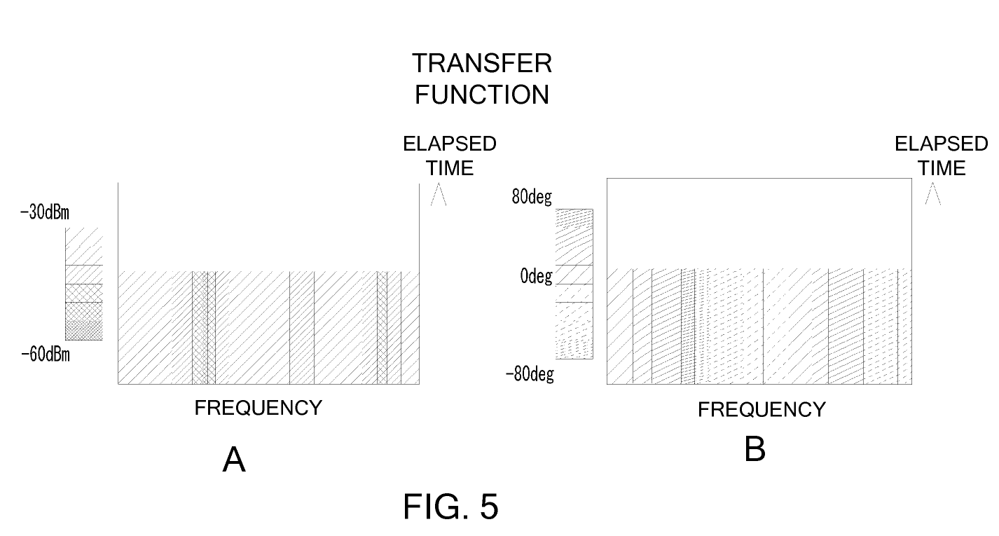

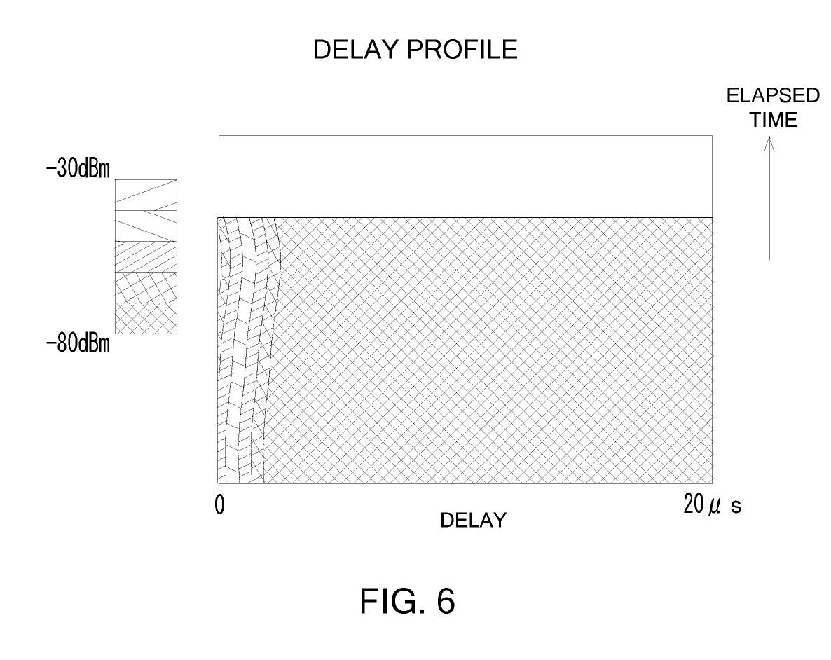

FIG. 5 shows examples of measurement results of transfer functions. FIG. 5A is a display of showing relationship between frequencies and powers (amplitudes) of transfer functions wherein the horizontal and vertical axes are frequency and elapsed time respectively, for example, and the power is represented with colors or brightness, as indicated by the varying hatch patterns. FIG. 5B is a display of showing relationship between frequencies and phases of the transfer functions wherein the horizontal and vertical axes are frequency and elapsed time respectively, for example, and the phase is represented with colors or brightness similar to FIG. 5A. Note that, for convenience of explanation, the colors or brightness in FIGS. 5 and 6 (described below) change step by step but an actual one can display with colors or brightness that are continuous tone for precisely displaying the measurement results.

FIG. 6 shows an example of measurement results of the delay profiles and shows a relationship between delay and power (amplitude). In FIG. 6, the horizontal axis may be delay time and the vertical axis may be elapsed time. The powers may be represented with colors or brightness.

The display processing block 171 of the display block 17 updates the display of the display device 172 every time the signal processing block 16 provides the measurement results to display the propagation characteristics similar to FIGS. 5 and 6. This allows displaying the measurement results soon after the measurement starts even if the elapsed time range for a display is long. Alternatively, the measurement results provided from the signal processing block 16 may be stored sequentially and when the measurement results for an amount of an elapsed time to display on the screen of the display device 172 are stored, the propagation characteristics are displayed.

As described, if elapsed time is set as one of the coordinate axes and frequency or delay time is set as the other to display a two dimensional coordinate display, and powers (amplitudes) or phases are represented with colors or brightness to display the propagation characteristics, time variation of the propagation characteristics can be easily realized. Besides, unlike the waterfall display it does not hide a waveform so that it makes it sure to see the time variation of the propagation characteristics. Further, embodiments of the present invention are useful for designing mobile transmitter/receiver, to make settings of a transmitter station, etc. because it makes it possible to easily realize change of the propagation characteristics even if the propagation characteristics change with time like radio wave propagation characteristics of a mobile communication.

What is claimed is:

1. A method for displaying propagation characteristics comprising steps of:
calculating propagation characteristics of a propagation path from a signal under test; and
displaying the calculated propagation characteristics wherein the propagation characteristics is displayed on a two dimensional coordinate, one axis of the two dimensional coordinate is time, and the calculated results of the propagation characteristics are represented with colors or brightness on the two dimensional coordinate in the displaying step.

2. The method for displaying the propagation characteristics as recited in claim 1 wherein transfer functions are calculated as the propagation characteristics in the propagation characteristics calculation step, and amplitudes or phases of the transfer functions are represented with colors or brightness as frequency and time are the coordinate axes in the displaying step.

3. The method for displaying the propagation characteristics as recited in claim 2 wherein delay profiles are calculated in the propagation characteristics calculating step by conducting Fourier transform of the calculated transfer functions, and amplitudes of the delay profiles are represented with colors or brightness as delay time and time are the coordinate axes in the displaying step.

4. An apparatus for measuring propagation characteristics comprising:
a signal processing block for calculating propagation characteristics of a propagation path from a signal under test; and
a display block for displaying the calculated propagation characteristics wherein the display block displays the propagation characteristics on a two dimensional coordinate, one axis of the two dimensional coordinate is time, and the calculated results of the propagation characteristics are represented with colors or brightness on the two dimensional coordinate.

5. The apparatus for measuring the propagation characteristics as recited in claim 4 wherein the signal processing block calculates transfer functions as the propagation characteristics, and the display block represents amplitudes or phases of the transfer functions with colors or brightness as frequency and time are the coordinate axes.

6. The apparatus for measuring the propagation characteristics as recited in claim 5 wherein the signal processing block calculates delay profiles by conducting Fourier transform of the calculated transfer functions, and the display block represents amplitudes of the delay profiles with colors or brightness as delay time and time are the coordinate axes.
